(19) United States
(12) Patent Application Publication
(10) Pub. No.: US 2019/0319500 A1
(43) Pub. Date: Oct. 17, 2019

(54) SPLIT CORE UNIT, ROTARY ELECTRIC MACHINE, METHOD FOR MANUFACTURING SPLIT CORE UNIT, AND METHOD FOR MANUFACTURING ROTARY ELECTRIC MACHINE

(71) Applicant: Mitsubishi Electric Corporation, Chiyoda-ku, Tokyo (JP)

(72) Inventors: Masaki SHINOHARA, Tokyo (JP); Daisuke SHIJO, Tokyo (JP); Tatsuya KITANO, Tokyo (JP); Norito KANDA, Chiyoda-ku, Tokyo (JP)

(73) Assignee: Mitsubishi Electric Corporation, Chiyoda-ku, Tokyo (JP)

(21) Appl. No.: 16/343,820

(22) PCT Filed: Dec. 18, 2017
(86) PCT No.: PCT/JP2017/045311

§ 371 Date: Apr. 22, 2019

(30) Foreign Application Priority Data
Jan. 11, 2017 (JP) 2017-002599

(51) Int. Cl. H02K 1/14; H02K 3/32; H02K 15/02; H02K 15/10

(52) U.S. Cl. CPC H02K 1/148; H02K 15/10; H02K 15/022; H02K 3/325

(57) ABSTRACT

The split core unit includes a split core, a coil, and an insulating member insulating the split core from the coil. The insulating member has end-surface insulating members. Each end-surface insulating member has, at a circumferential-direction center of the outer circumferential surface, a straight-shaped first groove extending in the axial direction. A yoke portion of the split core has, at a circumferential-direction center of the outer circumferential surface, a straight-shaped second groove extending in the axial direction over the entire length of the split core. The first grooves of the two end-surface insulating members and the second groove of the split core communicate with each other. The two first grooves appear to overlap the second groove as seen in the axial direction.

### TECHNICAL FIELD

The present invention relates to a split core unit, a rotary electric machine, a method for manufacturing a split core unit, and a method for manufacturing a rotary electric machine.

### BACKGROUND ART

Conventionally, a technique has been proposed in which a core for a rotary electric machine is formed by combining a plurality of split cores split in the circumferential direction. Each split core is composed of a yoke portion and a tooth portion, and is formed by stacking steel sheets formed in substantially a T shape. Further, at a part where winding is performed on the split core, an insulator (insulating member) made of synthetic resin or the like is externally mounted for allowing winding of a magnet wire while ensuring insulation between the coil and the stacked steel sheets.

In the case where the insulator is formed as a separate part and then integrated with the split core, the insulator may be split into three parts in order to provide the insulators over the entire circumference of the part where winding is performed on the split core. In the case of this type of insulator, a pair of L-shaped members for covering three surface parts, i.e., longitudinal wall parts on both sides in the circumferential direction of the tooth of the split core and one coil-end-side end surface, are arranged so as to be opposed to each other, and the other coil-end-side end surface of the split core is covered by a protrusion member formed so as to protrude in the axial direction from the other coil-end-side end surface (see, for example, Patent Document 1).

In the case of winding a magnet wire around the split core described in Patent Document 1, the magnet wire is wound in a state in which an insulator composed of a plurality of split parts is attached to the split core. Therefore, by a tension applied to the coil during winding, the parts composing the insulator and the split core are displaced from a predetermined positional relationship, so that the magnet wire cannot be located at a predetermined position on the split core. Thus, regularity of the coil is deteriorated, whereby performance of the rotary electric machine might be reduced.

Accordingly, in order to prevent occurrence of the above “displacement”, an insulator having another shape has been proposed which has side wall members provided so as to cover side surfaces along the longitudinal direction of the split core, and protrusion members provided so as to protrude outward from both ends in the longitudinal direction in order to guide a wire on the outer side at both ends in the longitudinal direction of the split core. In this technique, the protrusion members have flange portions for covering a wire on the outer side at both ends in the longitudinal direction of the split core, from the inner and outer sides in the radial direction of a core.

Each flange portion has a retained surface on which a retention member for pressing the protrusion member in the radial direction of the core so as to fix the protrusion member abuts at the time of winding a magnet wire. A retaining surface of the retention member, which abuts on the retained surface, has an engagement projection/recess portion, and the retained surface has an engagement projection/recess portion having a shape to be engaged with the engagement projection/recess portion of the retaining surface. At the time of winding the magnet wire, the retention member and the protrusion member are engaged and fixed with each other. The protrusion member has a latch piece for preventing the side wall member from being detached from the split core (see, for example, Patent Document 2).

### CITATION LIST

### Patent Document

Patent Document 1: Japanese Laid-Open Patent Publication No. 2008-43107

Patent Document 2: Japanese Laid-Open Patent Publication No. 2011-72093

### SUMMARY OF THE INVENTION

### Problems to be Solved by the Invention

In winding of the magnet wire around the split core proposed in Patent Document 2, the protrusion member is fixed with the retained surface pressed, whereby positional displacement between the protrusion member and the side wall member of the insulator due to a tension applied to the magnet wire during winding can be prevented. However, it is necessary to perform replacement with a dedicated retention tool for each machine type in accordance with shape variations of split cores and protrusion members in the case of producing different types of rotary electric machines, in particular, variations in the curvature of the retained surface of the protrusion member and variations in the axial-direction position where the protrusion member is placed. Thus, there is a problem of requiring a labor for replacement work and cost for the dedicated retention tool.

The present invention has been made to solve the above problem, and an object of the present invention is to provide a split core unit, a rotary electric machine, a method for manufacturing a split core unit, and a method for manufacturing a rotary electric machine, that facilitate replacement work in the case of producing different types of rotary electric machines, and do not require a dedicated retention tool for each machine type.

### Solution to the Problems

A split core unit according to the present invention is a split core unit including: a split core having a yoke portion and a tooth portion protruding radially inward from the yoke portion; a coil formed by winding a magnet wire around the tooth portion; and an insulating member electrically insulating the split core and the coil from each other, wherein the insulating member has end-surface insulating members respectively covering both end surfaces in an axial direction of the split core, each end-surface insulating member has, at a circumferential-direction center of an outer circumferential surface thereof, a straight-shaped first groove extending in the axial direction, the yoke portion has, at a circumferential-direction center of an outer circumferential surface of the split core, a straight-shaped second groove extending in the axial direction over an entire length of the yoke portion, the two first grooves and the second groove communicate with each other, and the two first grooves appear to overlap the second groove as seen in the axial direction.

A rotary electric machine according to the present invention is a rotary electric machine including: a stator formed by combining, in an annular shape, a plurality of the split core units; a frame that houses the stator; and a rotor rotatably supported on an inner side of the stator.

A method for manufacturing a split core unit according to the present invention is a method for manufacturing the split core unit, the method including: an insulating member attachment step of attaching each end-surface insulating member to the split core; a fixation step of inserting a holding tool having two holding nails longer than an axial length of the split core and openable and closable in a circumferential direction, into the two first grooves and the second groove, in a state in which the two holding nails are closed, and then opening the two holding nails in the circumferential direction, to press both side walls of the two first grooves and the second groove in the circumferential direction by the two holding nails, thereby fixing the two end-surface insulating members and the split core to the holding tool; and a winding step of forming a coil by winding a magnet wire around a split core unit intermediate body in which the two end-surface insulating members and the split core are fixed to each other.

A method for manufacturing a rotary electric machine according to the present invention is a method for manufacturing a rotary electric machine, the method including: a split core unit joining step of combining, in an annular shape, a plurality of the split core units manufactured by the method for manufacturing the split core unit, to form a stator; and a rotary electric machine assembling step of inserting the stator into a frame and fixing the stator, and rotatably providing a rotor to inside of the stator.

### Effect of the Invention

The split core unit, the rotary electric machine, the method for manufacturing the split core unit, and the method for manufacturing the rotary electric machine according to the present invention make it possible to provide a split core unit, a rotary electric machine, a method for manufacturing a split core unit, and a method for manufacturing a rotary electric machine, that facilitate replacement work in the case of producing different types of rotary electric machines, and do not require a dedicated retention tool for each machine type.

### BRIEF DESCRIPTION OF THE DRAWINGS

FIG. 1 is a sectional view of a rotary electric machine according to embodiment 1 of the present invention.

FIG. 2 is a front view of a split core unit according to embodiment 1 of the present invention.

FIG. 3 is an exploded view of a split core unit intermediate body according to embodiment 1 of the present invention.

FIG. 4 is a perspective view showing assembling of the split core unit intermediate body according to embodiment 1 of the present invention.

FIG. 5A is an enlarged perspective view of an end-surface insulating member according to embodiment 1 of the present invention.

FIG. 5B is an enlarged perspective view of the end-surface insulating member according to embodiment 1 of the present invention.

FIG. 6 is a flowchart showing a rotary electric machine manufacturing process according to embodiment 1 of the present invention.

FIG. 7 is a front view of the split core unit intermediate body fixed to a winding device, according to embodiment 1 of the present invention.

FIG. 8 is a front view showing a state in which a retention tool is inserted into a first groove and a second groove according to embodiment 1 of the present invention.

FIG. 9 is a front view showing a state in which a retention tool is opened, according to embodiment 1 of the present invention.

FIG. 10 is a front view of the split core unit intermediate body fixed to a flyer winding device, according to embodiment 1 of the present invention.

FIG. 11 is a front view showing the manner of winding for joined cores according to embodiment 2 of the present invention.

FIG. 12A is a front view of a split core unit intermediate body according to embodiment 3 of the present invention.

FIG. 12B shows a state of fixation between a retention tool, and two first grooves and a second groove, according to embodiment 3 of the present invention.

FIG. 13A is a front view of a split core unit intermediate body according to embodiment 4 of the present invention.

FIG. 13B shows a state of fixation between a retention tool, and two first grooves and a second groove, according to embodiment 4 of the present invention.

FIG. 14 is a side view of the retention tool and the split core unit intermediate body in the state shown in FIG. 9, as seen in the circumferential direction.

FIG. 15A is a front view of a split core unit intermediate body according to embodiment 5 of the present invention.

FIG. 15B shows a state of fixation between a retention tool, and two first grooves and a second groove, according to embodiment 5 of the present invention.

FIG. 16A is a front view of a split core unit intermediate body according to embodiment 6 of the present invention.

FIG. 16B shows a state of fixation between a retention tool, and two first grooves and a second groove, according to embodiment 6 of the present invention.

### DESCRIPTION OF EMBODIMENTS

### Embodiment 1

Hereinafter, a split core unit, a rotary electric machine, a method for manufacturing a split core unit, and a method for manufacturing a rotary electric machine according to embodiment 1 of the present invention, will be described with reference to the drawings.

As used herein, unless specifically stated, an “axial direction”, a “circumferential direction”, a “radial direction”, an “inner circumferential side”, an “outer circumferential side”, an “inner circumferential surface”, and an “outer circumferential surface” respectively refer to an “axial direction”, a “circumferential direction”, a “radial direction”, an “inner circumferential side”, an “outer circumferential side”, an “inner circumferential surface”, and an “outer circumferential surface” of a stator formed by combining split core units. In addition, as used herein, unless specifically stated, when “upper” or “lower” is mentioned, a plane perpendicular to the axial direction is assumed at a location as a reference, and using the plane as a border, a side that includes the center point of the stator is defined as “lower” side and the opposite side is defined as “upper” side.

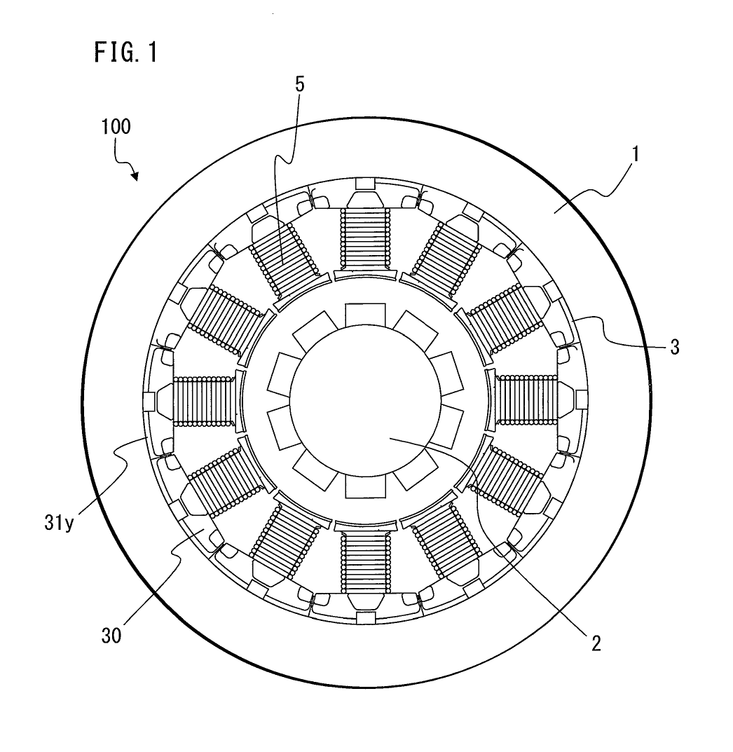

FIG. 1 is a sectional view of a rotary electric machine 100.

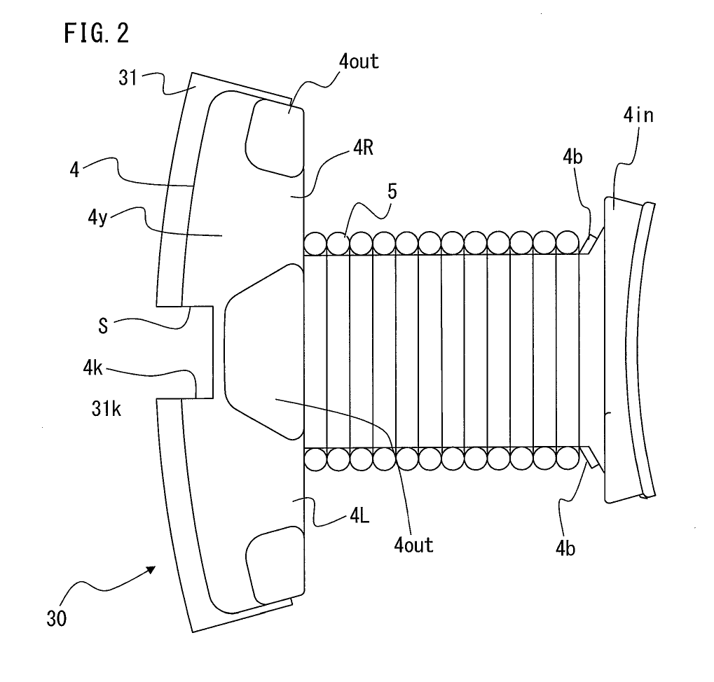

FIG. 2 is a top view of a split core unit 30.

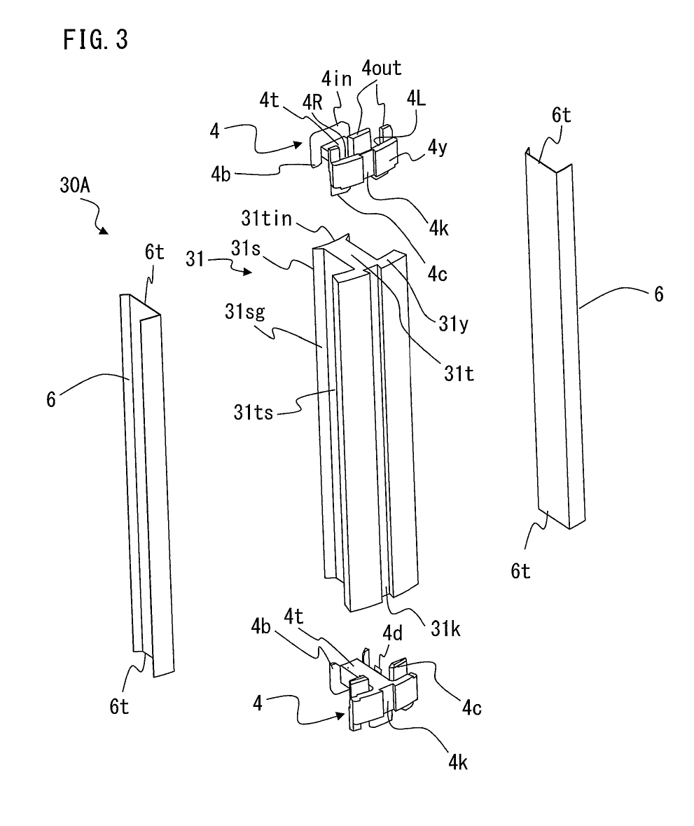

FIG. 3 is an exploded view of a split core unit intermediate body 30A.

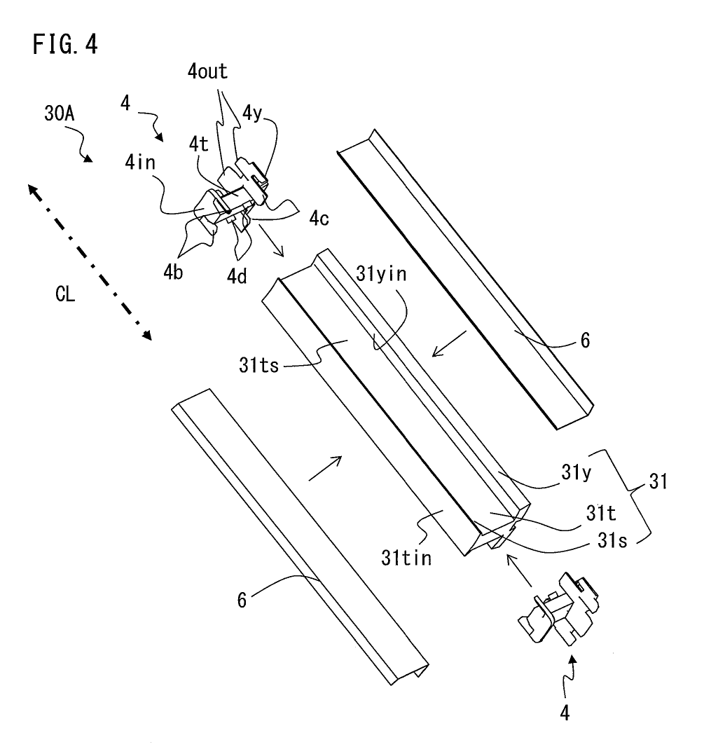

FIG. 4 is a perspective view showing assembling of the split core unit intermediate body 30A.

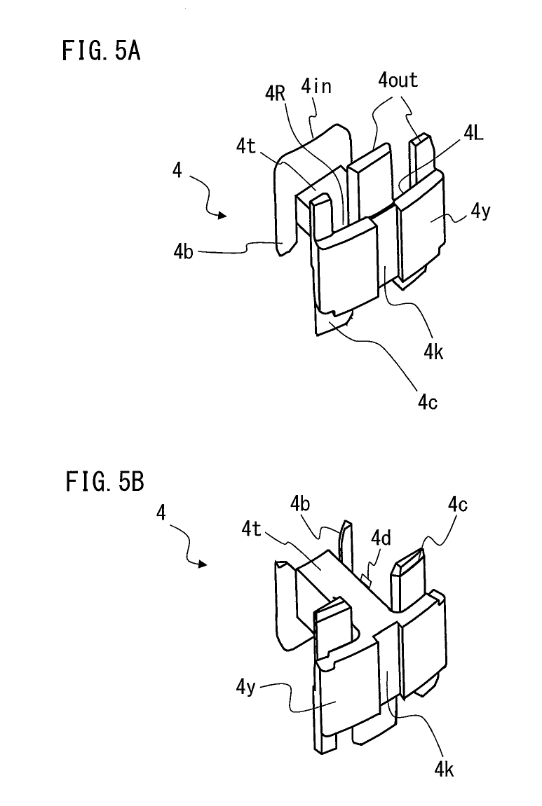

FIG. 5A and FIG. 5B are perspective views of an end-surface insulating member 4. FIG. 5A is a perspective view as seen from the upper side, and FIG. 5B is a perspective view as seen from the lower side.

The rotary electric machine 100 has a frame 1, a rotor 2, and a stator 3. The frame 1 has a hollow cylindrical shape, and the outer circumferential surface of the stator 3 is fitted to the inner circumferential surface of the frame 1. The rotor 2 has magnets arranged with their outer circumferential surfaces opposed to the inner circumferential surface of the stator 3, and is supported rotatably with respect to the stator 3 by a bearing (not shown). The stator 3 is composed of twelve split core units 30 arranged in an annular shape. The number of the split core units 30 is not limited to twelve.

The split core unit 30 is composed of: a split core 31 formed by stacking steel sheets in the direction perpendicular to the drawing plane in FIG. 2; a coil 5; and an insulating member for electrically insulating the split core 31 and the coil 5 from each other. As shown in FIGS. 3 and 4, the split core 31 is formed of a yoke portion 31y having an arc-shaped outer periphery, a tooth portion 31t protruding radially inward from the yoke portion 31y, and shoe portions 31s protruding toward both sides in the circumferential direction from a radially inner end 31tin of the tooth portion 31t. The insulating member includes side-surface insulating members 6 for covering both side walls in the circumferential direction of the tooth portion 31t of the split core 31, and end-surface insulating members 4 for covering the axial end surfaces of the tooth portion 31t and parts of the axial end surfaces of the yoke portion 31y.

The split core unit intermediate body 30A is a body before a magnet wire is wound for the split core unit 30.

In a state in which the side-surface insulating members 6 and the end-surface insulating members 4 are attached to the split core 31, a magnet wire W is wound around the tooth portion 31t so as to mount the coil 5 to the split core unit intermediate body 30A, whereby the split core unit 30 is obtained.

In FIG. 1, for simplification, the surfaces of the adjacent yoke portions 31y that are in contact with each other in the stator 3 are shown in a planar shape. However, one of these surfaces may have a recess and the other may have a projection, so as to form an engagement structure.

As shown in FIGS. 3 and 4, each side-surface insulating member 6 has a shape that covers a circumferential-direction side surface 31ts of the tooth portion 31t of the split core 31, an inner circumferential surface 31yin of the yoke portion 31y, and an outer circumferential surface 31sg of the shoe portion 31s, and has a length corresponding to the entire length in the longitudinal direction (axial direction CL) of the split core 31. It is noted that the side-surface insulating members 6 are made of an insulating material such as paper.

As shown in FIG. 3 to FIG. 5, in order to cover the axial end surfaces of the split core 31, each end-surface insulating member 4 is shaped to have substantially the same cross section as the cross section perpendicular to the longitudinal direction of the split core 31, and protrudes upward in the axial direction by a predetermined length from the longitudinal-direction end surface of the split core 31. A part that covers the axial end surface of the tooth portion 31t is a tooth covering portion 4t. A part that covers the axial end surface of the yoke portion 31y is a yoke covering portion 4y. The width in the radial direction of the yoke covering portion 4y is smaller than the width in the radial direction of the yoke portion 31y of the split core 31. The end-surface insulating members 4 are made of an insulating synthetic resin. For the end-surface insulating members 4, another shape or material may be employed.

Each end-surface insulating member 4 has an inner flange 4in and an outer flange 4out that stand in the axial direction. The inner flange 4in stands upward from the axial end surface of the inner end 31tin of the tooth portion 31t and the axial end surfaces of the shoe portions 31s. The outer flange 4out stands in the axial direction from the upper side of the yoke covering portion 4y, along a slightly inner side with respect to the inner-circumferential-side edge of the axial end surface of the yoke portion 31y. The inner flange 4in, the outer flange 4out, and the tooth covering portion 4t form a winding frame for the coil 5.

Therefore, the lengths by which the inner flange 4in and the outer flange 4out protrude in the axial direction from the tooth covering portion 4t (the amounts of protrusions in the longitudinal direction of the split core 31) are set to be equal to or greater than the thickness in the axial direction of the coil 5 on the tooth covering portion 4t.

As shown in FIG. 3 to FIG. 5, the inner flange 4in of the end-surface insulating member 4 has a pair of engagement nails 4b (first engagement nails) to be engaged with the outer circumferential surfaces 31sg of the shoe portions 31s by the elastic restoration force of resin in a state of being attached to the split core 31. The yoke covering portion 4y has a pair of engagement nails 4c (second engagement nails) to be engaged with the inner circumferential surface 31yin of the yoke portion 31y by the elastic restoration force of resin in a state of being attached to the split core 31. Thus, the end-surface insulating member 4 is retained in a provisionally fixed state to the axial end surface of the split core 31.

The tooth covering portion 4t has, at the radial-direction centers of the side surfaces, protrusions 4d protruding downward in the axial direction along the circumferential-direction side surfaces 31ts of the tooth portion 31t. Axial end portions 6t of the side-surface insulating members 6 are retained by being placed between the protrusions 4d and the tooth portion 31t.

Thus, it is possible to easily prevent the side-surface insulating members 6 from being detached from the split core 31 in a state in which the end-surface insulating members 4 and the side-surface insulating members 6 are attached to the split core 31 (at a stage before winding). In addition, the split core unit intermediate body 30A in a state before the coil is formed can be handled as one piece without bonding and fixing the end-surface insulating members 4 and the side-surface insulating members 6 to the split core 31.

As shown in FIG. 3, the outer flange 4out has a guide groove 4L for positioning the winding start end of the coil 5 and leading a magnet wire to outside so as to be fixed, and a winding hook groove 4R for hooking the winding finish end after completion of winding so as to be provisionally fastened.

The yoke covering portion 4y has, at the circumferential-direction center of the outer circumferential surface, a straight-shaped first groove 4k which extends in the axial direction and of which the cross section perpendicular to the axial direction has a rectangular shape that opens on one side. The width in the radial direction of the first groove 4k is smaller than the width in the radial direction of a second groove 31k. The split core 31 has, at the circumferential-direction center of the outer circumferential surface, the second groove 31k extending in the axial direction over the entire length of the split core 31. In a state in which the end-surface insulating members 4 are attached to both end surfaces in the axial direction of the split core 31, the first grooves 4k of the two end-surface insulating members 4 and the second groove 31k of the split core 31 straightly communicate with each other. The two first grooves 4k appear to overlap the second groove 31k when seen in the axial direction.

Next, the method for manufacturing the rotary electric machine 100 will be described.

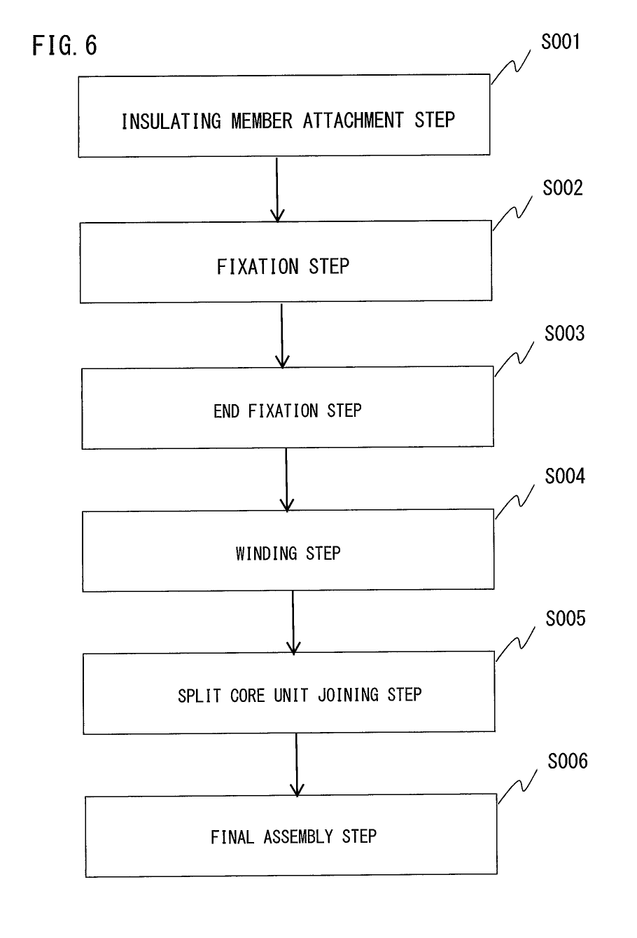

FIG. 6 is a flowchart showing the process for manufacturing the rotary electric machine 100.

First, as shown in FIG. 3 and FIG. 4, the side-surface insulating members 6 are mounted to the split core 31, and the end-surface insulating members 4 are mounted from both sides in the axial direction of the split core 31 such that the first grooves 4k and the second groove 31k communicate with each other in the axial direction (step S001: insulating member attachment step).

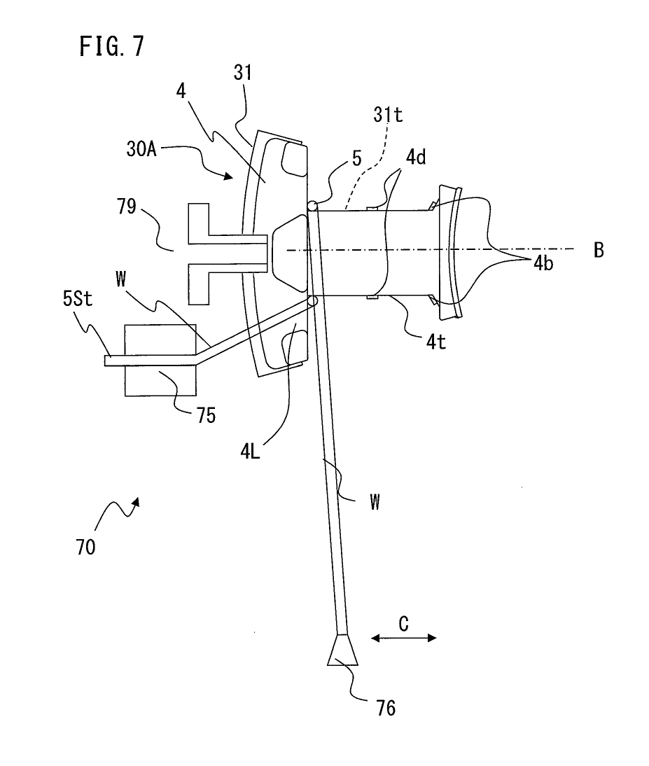

FIG. 7 is a front view of the split core unit intermediate body 30A fixed to a winding device 70.

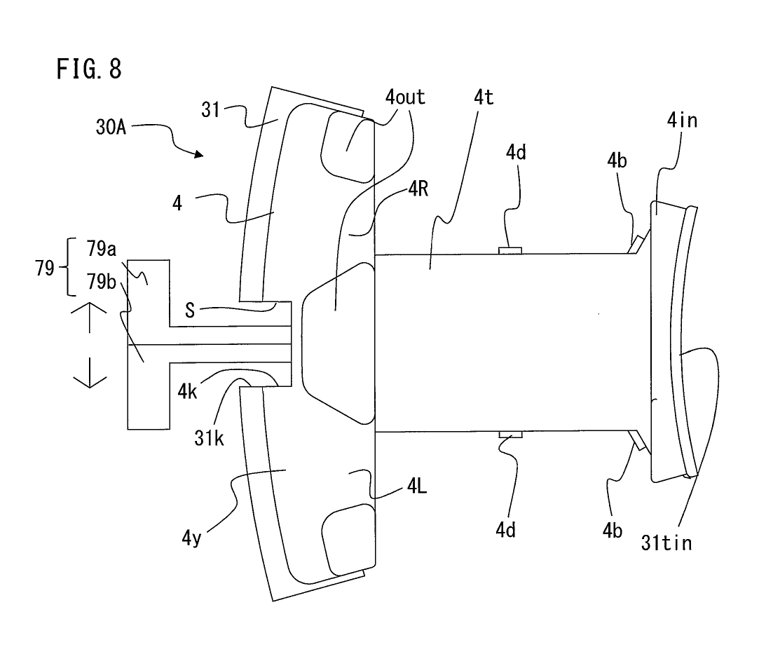

FIG. 8 is a front view showing a state in which a retention tool 79 is inserted into the first grooves 4k and the second groove 31k.

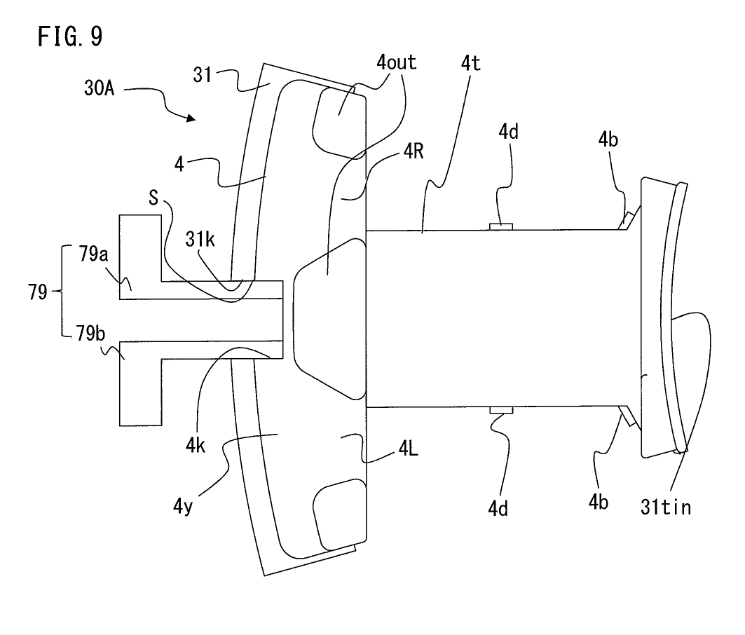

FIG. 9 is a front view showing a state in which the retention tool 79 is opened.

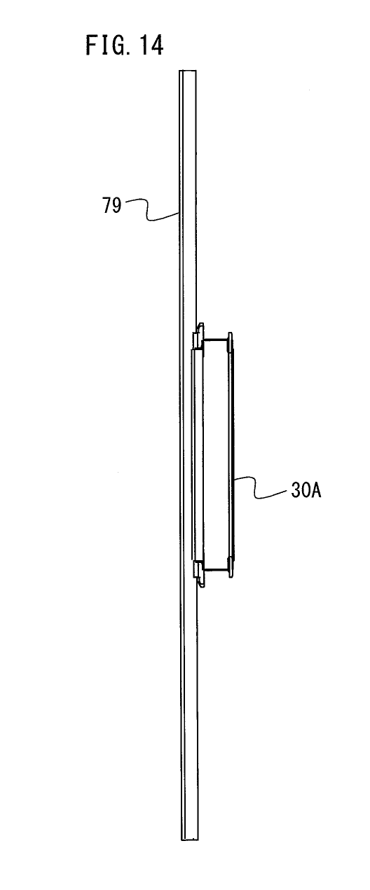

FIG. 14 is a side view of the retention tool and the split core unit intermediate body in the state shown in FIG. 9, as seen in the circumferential direction.

The winding device 70 includes: a chuck 75 for grasping a winding start end 5St of the coil 5 led out from the guide groove 4L of the outer flange 4out described above; the retention tool 79 for fixing the split core unit intermediate body 30A; and a nozzle 76 for feeding a magnet wire W. The retention tool 79 is composed of a holding nail 79a and a holding nail 79b. The holding nails 79a, 79b are respectively movable in the arrow directions shown in FIG. 8. That is, the retention tool 79 is configured such that the holding nail 79a and the holding nail 79b are openable and closable in the circumferential direction. The entire length in the axial direction of the holding nails 79a, 79b is longer than the second groove 31k. As shown in FIG. 14, the entire length in the axial direction of the holding nails 79a, 79b may be greater than the total length in the axial direction of the two first grooves 4k and the second groove 31k that communicate with each other.

Subsequent to step S001, as shown in FIG. 8, in a state in which the holding nails 79a, 79b of the retention tool 79 are closed, the holding nails 79a, 79b are inserted inward from the outer circumferential side to the bottoms of the two first grooves 4k and the second groove 31k, and then are opened in the circumferential direction as shown in FIG. 9. Thus, the holding nails 79a, 79b press both side walls S formed by the two first grooves 4k and the second groove 31k toward respective opposite sides in the circumferential direction, and with the frictional force therebetween, the two end-surface insulating members 4 and the split core 31 are fixed to the retention tool 79 (step S002: fixation step).

In this way, since the two first grooves 4k and the second groove 31k are provided in the longitudinal direction of the split core 31, the holding nails 79a, 79b are to press the split core 31 in the circumferential direction. Therefore, during winding of a magnet wire, the positions of the end-surface insulating members 4 can be prevented from being displaced in the circumferential direction relative to the split core 31.

First, before the start of winding of the magnet wire W, the winding start end 5St is grasped and fixed by the chuck 75 (step S003: end fixation step). Thus, the magnet wire W is positioned by the guide groove 4L, and positioning for the winding start position is ensured, whereby it is possible to more accurately wind the magnet wire W to a predetermined position, as compared to the case where the winding start end of the magnet wire W is not fixed.

Next, the nozzle 76 for feeding the magnet wire W is located at a position that is radially inward of the outer flange 4out and separate in the circumferential direction from the split core unit intermediate body 30A. Then, the split core unit intermediate body 30A is rotated about a center axis B in the radial direction of the tooth portion 31t and is moved in the direction of arrow C in FIG. 7, whereby the magnet wire W is wound around the split core unit intermediate body 30A (step S004: winding step).

Next, the split core units 30 for which the magnet wires W have been wound are arranged in an annular shape and fixed, and the winding start end and the winding finish end of each coil 5 are electrically connected to a printed board or the like (not shown), thereby obtaining the stator 3 shown in FIG. 1 (step S005: split core unit joining step). Then, the stator 3 is inserted to the inside of the frame 1 and fixed, and the rotor 2 is rotatably provided to the inside of the stator 3, thereby obtaining the rotary electric machine 100 (step S006: rotary electric machine assembling step).

In winding of the magnet wire W around the split core unit intermediate body 30A, when a tension occurs in the magnet wire W and the end-surface insulating members 4 are subjected to an external force due to the tension, a force that causes displacement in the circumferential direction relative to the split core 31 is applied to the end-surface insulating members 4. The end-surface insulating members 4 are provisionally fastened to the split core 31 by the elastic restoration forces of the engagement nails 4b and the engagement nails 4c, and therefore, when the above tension is applied to the end-surface insulating members 4, if the tension is within the elasticity range, the end-surface insulating members 4 are displaced in the circumferential direction from the end surfaces of the split core 31, and if the tension exceeds the elasticity range, the engagement nails 4b, 4c might be broken.

Accordingly, in the present embodiment, the two end-surface insulating members 4 and the split core 31 are fixed by the same retention tool 79 pressing both side walls S of the groove formed by the two first grooves 4k and the second groove 31k which are respectively provided thereto so as to communicate with each other, and then the magnet wire W is wound. Thus, the end-surface insulating members 4 and the split core 31 are perfectly prevented from being displaced during winding.

The split core unit, the rotary electric machine, the method for manufacturing the split core unit, and the method for manufacturing the rotary electric machine according to embodiment 1 of the present invention make it possible to provide a split core unit, a rotary electric machine, a method for manufacturing a split core unit, and a method for manufacturing a rotary electric machine, that facilitate replacement work in the case of producing different types of rotary electric machines, and do not require a dedicated retention tool for each machine type.

In addition, by the end-surface insulating members 4 fixed to the split core 31, the side-surface insulating members 6 are also retained on both side surfaces in the circumferential direction of the tooth portion 31t of the split core 31. Therefore, without bonding and fixing the side-surface insulating members 6 and the split core 31 to each other, it is possible to wind the magnet wire W while preventing displacement of the side-surface insulating members 6 as well.

Thus, since an adhesive is not used, the material cost for an adhesive can be reduced, and various management complexities and the like can be eliminated. Also, an applicator for an adhesive, a curing oven for an adhesive, or the like is not needed, and thus equipment investment cost can be reduced. In addition, since an adhesive application process is eliminated, the installation space for the production line can be reduced. Therefore, it is possible to promote productivity improvement and cost reduction for the split core unit 30 and the rotary electric machine 100 using the split core 31.

The engagement nails 4b provided to the inner flange 4in of each end-surface insulating member 4 are engaged with the outer circumferential surfaces 31sg of the shoe portions 31s by the elastic restoration force of resin, and similarly, the engagement nails 4c provided to the outer flange 4out are engaged with the inner circumferential surface 31yin of the yoke portion 31y, whereby the relative positions of the end-surface insulating members 4 with respect to the split core 31 are determined. Therefore, in the case of employing a method of performing winding in a state in which the split core and the end-surface insulating members are fixed to the winding device by respective different retention tools as in the conventional case, the relative positional relationship between the split core and the end-surface insulating members varies within an exertion range of the elastic restoration forces of protrusions.

In contrast, in the case of using the retention tool according to the present embodiment, since the two end-surface insulating members 4 and the split core 31 are fixed by one retention tool 79, the relative positional relationship between the split core 31 and the end-surface insulating members 4 does not vary. Thus, during winding of the magnet wire W, the positional relationship between the split core unit intermediate body 30A and the trajectory of the magnet wire W can be stabilized, so that the coil 5 can be provided at a predetermined position on the split core unit 30. As a result of improvement in regularity of the coil 5, the number of turns of the coil 5 can be increased, and output of the rotary electric machine 100 can be enhanced.

The first grooves 4k of the two end-surface insulating members 4 and the second groove 31k of the split core 31 are provided in a straightly communicating manner in the axial direction of the split core unit intermediate body 30A, and the holding nails 79a, 79b of the retention tool 79 are inserted inward from the outer circumferential side of the split core 31. If the length in the axial direction of the retention tool 79 is matched with the longest one of the axial lengths of split cores of rotary electric machines to be produced, it is not necessary to change the retention tool in accordance with variations in the stacking thickness in the longitudinal direction of the split core, unlike the conventional case. Fixation of the two end-surface insulating members 4 and the split core 31 to the winding device is made by a frictional force obtained by the holding nails 79a, 79b of the retention tool 79 pressing both side walls S formed by the two first grooves 4k and the second groove 31k toward the respective opposite sides in the circumferential direction. Therefore, unlike the conventional case, it is not necessary to change the retention tool for the manufacturing of each of split core units that are different in the curvature of the inner circumferential surface of the shoe portions and the radially inner end of the tooth portion, the curvature of the outer circumferential surface of the yoke portion, and the curvature of the inner flange or the outer flange.

Therefore, change in the trajectory of the magnet wire W with respect to the split core unit intermediate body 30A at the time of winding, due to replacement work for the retention tool 79, does not occur, and the magnet wire W can be wound to a predetermined position on the split core unit intermediate body 30A, whereby regularity of the coil 5 can be improved. Thus, the number of turns of the coil 5 can be increased and output of the rotary electric machine 100 can be enhanced.

In addition, since the setup time for the retention tool 79 is shortened, productivity for the split core unit 30 can be improved.

In addition, since it is not necessary to change the retention tool 79 in accordance with the shape of the split core unit 30 to be manufactured, the number of the retention tools 79 can be decreased and management complexities for the retention tools can be reduced. In addition, as described above, the split core unit intermediate body 30A is fixed by the retention tool 79 from only one side, i.e., the outer circumferential side of the split core 31, and therefore, a retention tool for retaining the split core unit intermediate body from the inner circumferential side of the split core as in the conventional case is not necessary, so that the winding device can be downsized. Thus, the production line for the split core unit 30 using the split core 31 can be made inexpensive.

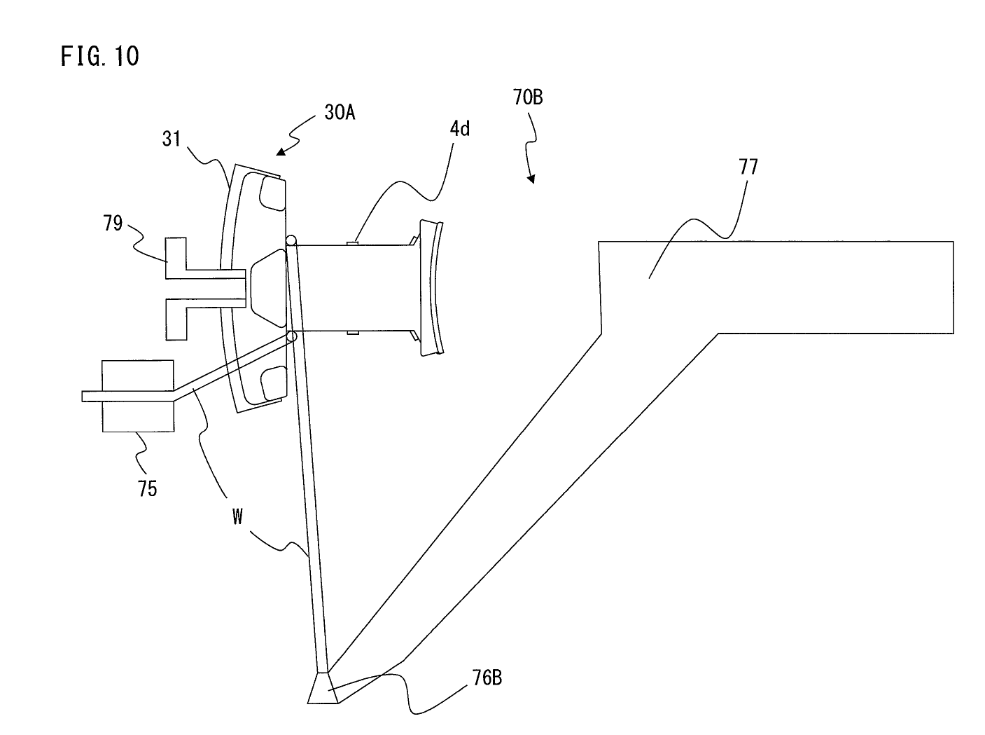

FIG. 10 is a front view of the split core unit intermediate body fixed to a flyer winding device 70B.

In the above description, the magnet wire W is wound around the split core unit intermediate body 30A by rotating the split core unit intermediate body 30A. However, another winding method, for example, a method generally called a flyer winding method as shown in FIG. 10 may be employed in which a flyer 77 having a nozzle 76B is revolved around the split core unit intermediate body 30A to wind the magnet wire W around the split core unit intermediate body 30A.

In winding of the magnet wire W, in the case of using the winding method of forming the coil 5 by rotating the split core unit intermediate body 30A, if the center of gravity of the split core unit intermediate body 30A is deviated from the rotation axis, an eccentric centrifugal force occurs on the split core unit intermediate body 30A in accordance with the rotation speed, thereby causing stress concentration on the contact surface between the retention tool 79 and the split core unit intermediate body 30A. On the other hand, in the case of flyer winding, such stress concentration does not occur, and therefore the speed of winding of the magnet wire W can be increased while the position of the center of gravity of the split core unit intermediate body 30A is neglected. Thus, productivity for the split core unit 30 can be improved. In particular, this is effective for winding for the split core unit intermediate body 30A having a large volume and a large mass.

In the case where a retention tool is pressed to the split core unit from the radially inner side of the split core as in the conventional case, the flyer that rotationally moves during winding and the retention tool for fixing the split core are located on the radially inner side of the split core, and therefore the mechanism of the winding device is likely to be complicated and enlarged. In contrast, in the present embodiment, the retention tool on the radially inner side is not needed. Therefore, as compared to the conventional case, the configuration of the flyer winding device 70B can be simplified and downsized, and the production line for the split core unit 30 and the rotary electric machine 100 can be made inexpensive.

### Embodiment 2

Hereinafter, a split core unit, a rotary electric machine, a method for manufacturing a split core unit, and a method for manufacturing a rotary electric machine according to embodiment 2 of the present invention, will be described with reference to the drawings.

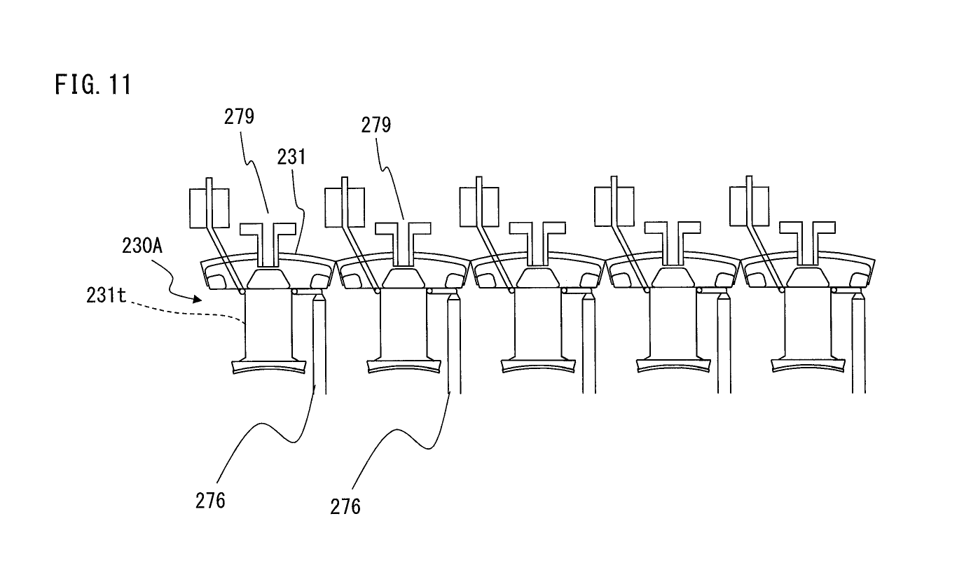

FIG. 11 is a front view showing the manner of winding in the case of using joined cores.

In embodiment 1, winding of the magnet wire W is performed for the split core unit intermediate body 30A having each of the split cores 31 that are split apart. In the present embodiment, winding is performed in a state in which the circumferential-direction ends of a plurality of split cores 231 are joined to each other by thin portion or joinable insulating members.

By joining the plurality of split cores 231, it is possible to form the split core units into an annular shape with increased workability so as to manufacture the stator 3. In addition, by performing press-stamping of magnetic steel sheets in a shape in which the circumferential-direction ends of core pieces composing the split cores 231 are joined via thin portions so as to form an annular shape, it is possible to increase the roundness of a core in a state in which the joined cores are combined in an annular shape, as compared to the case where core pieces are separately press-stamped without being joined to each other. Thus, the gap between the outer circumferential surface of the rotor 2 and the inner circumferential surface of the stator 3 can be uniformed over the entire circumference, whereby torque pulsation of a rotary electric machine can be suppressed.

As shown in FIG. 11, in the case of winding magnet wires W for a plurality of split core unit intermediate bodies 230A having joined split cores 231, a method generally called nozzle winding as shown below is used.

First, in a state in which the plurality of split core unit intermediate bodies 230A are fixed to retention tools 279 of a winding device from the outer circumferential side, nozzles 276 are inserted between adjacent tooth portions 231t from the inner side. Next, by revolving the nozzles 276 around the tooth portions 231t, the magnet wires W are wound around the split core unit intermediate bodies 230A.

With the plurality of split core unit intermediate bodies 230A joined to each other, the plurality of nozzles 276 are inserted between the split core unit intermediate bodies 230A to perform winding for them simultaneously. Thus, the magnet wires W can be wound for all the split core unit intermediate bodies 230A composing the stator 3 at once, whereby productivity for the stator 3 can be further improved as compared to embodiment 1.

The split core unit, the rotary electric machine, the method for manufacturing the split core unit, and the method for manufacturing the rotary electric machine according to the present embodiment provide the effects described in embodiment 1 and in addition, make it possible to form the coils 5 for the plurality of split core unit intermediate bodies 230A at the same time.

### Embodiment 3

Hereinafter, a split core unit, a rotary electric machine, a method for manufacturing a split core unit, and a method for manufacturing a rotary electric machine according to embodiment 3 of the present invention, will be described with reference to the drawings.

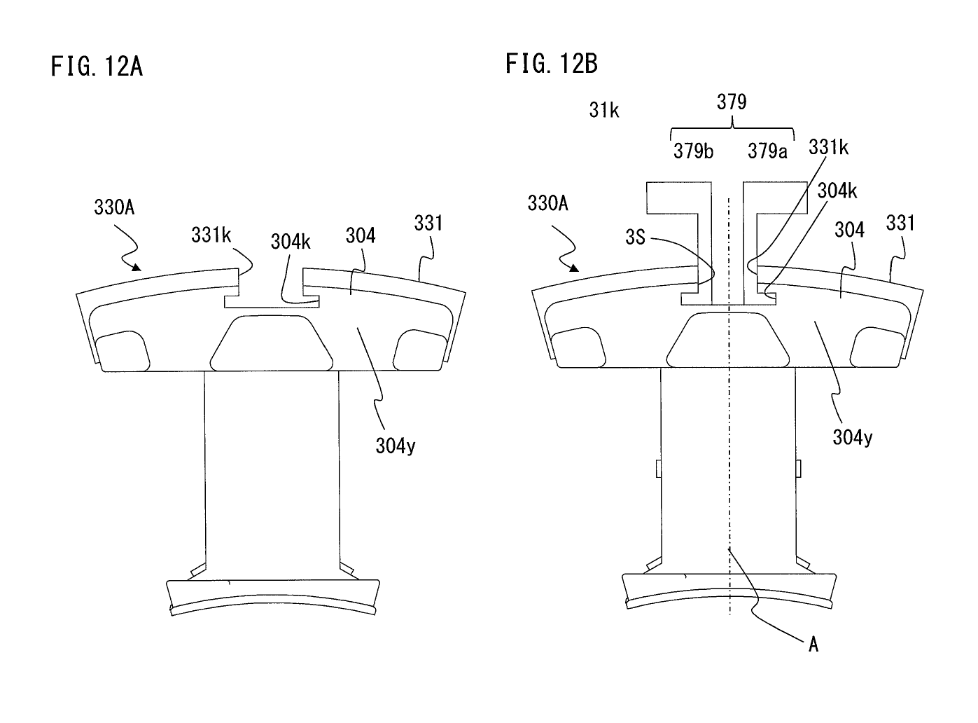

FIG. 12A is a front view of a split core unit intermediate body 330A.

FIG. 12B shows a state of fixation between a retention tool 379, and two first grooves 304k and a second groove 331k.

A yoke covering portion 304y has, at the circumferential-direction center of the outer circumferential surface, a first groove 304k extending in the axial direction and having a T-shaped cross section perpendicular to the axial direction. A split core 331 has, at the circumferential-direction center of the outer circumferential surface, a second groove 331k extending in the axial direction over the entire length of the split core 331 and having a T-shaped cross section perpendicular to the axial direction. The first groove 304k and the second groove 331k are formed such that the groove bottoms thereof, i.e., the radially inner sides thereof spread in the circumferential direction.

In a state in which the end-surface insulating members 304 are respectively attached to both end surfaces in the axial direction of the split core 331, the first grooves 304k of the two end-surface insulating members 304 and the second groove 331k of the split core 331 communicate with each other straightly. As shown in FIG. 12A, the two first grooves 304k appear to overlap the second groove 331k as seen in the axial direction.

The cross section perpendicular to the axial direction, of a holding nail 379a of the retention tool 379, has an L shape in which the radially inner end protrudes in the circumferential direction, and a holding nail 379b has a shape symmetric with the holding nail 379a with respect to a line A equally dividing the first groove 304k shown in FIG. 12B in the radial direction. The holding nails 379a, 379b are movable in the circumferential direction inside the first grooves 304k and the second groove 331k. After both holding nails are inserted into the first grooves 304k and the second groove 331k, when the holding nails are moved in the circumferential direction so as to be separated from each other, each holding nail is fitted and fixed along one of both side walls 3S of the groove formed by the two first grooves 304k and the second groove 331k.

The split core unit, the rotary electric machine, the method for manufacturing the split core unit, and the method for manufacturing the rotary electric machine according to the present embodiment provide the effects described in embodiment 1 and in addition, prevent the position of the split core unit intermediate body 330A from being displaced in the radial direction during winding of the magnet wire W, whereby winding accuracy for the magnet wire W is further improved, so that productivity for the split core unit and the rotary electric machine can be improved.

### Embodiment 4

Hereinafter, a split core unit, a rotary electric machine, a method for manufacturing a split core unit, and a method for manufacturing a rotary electric machine according to embodiment 4 of the present invention, will be described with reference to the drawings.

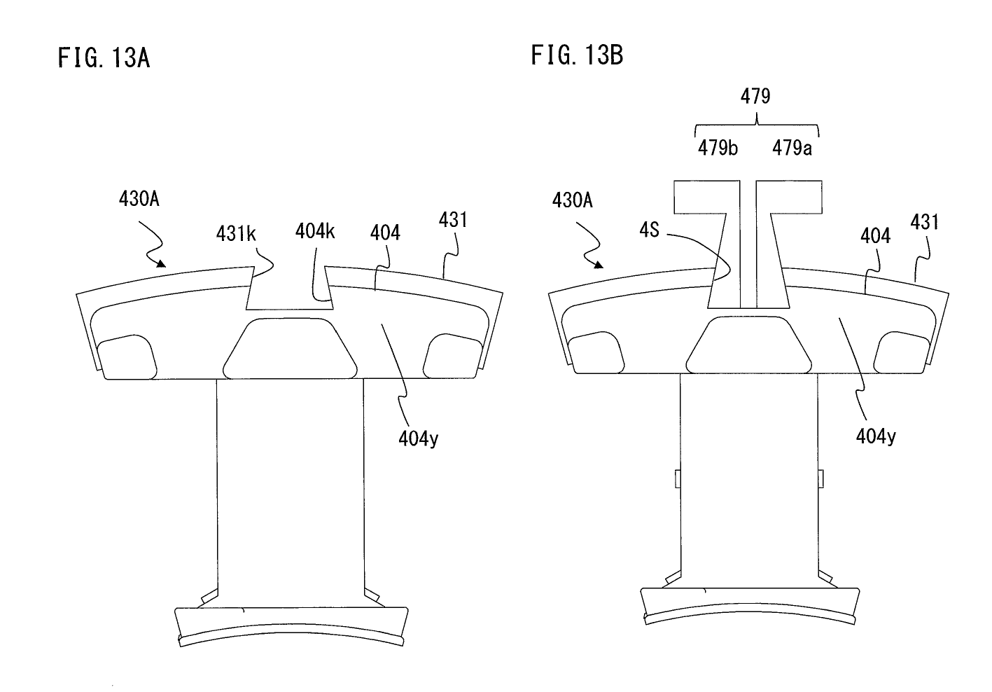

FIG. 13A is a front view of a split core unit intermediate body 430A.

FIG. 13B shows a state of fixation between a retention tool 479, and two first grooves 404k and a second groove 431k.

A yoke covering portion 404y of an end-surface insulating member 404 has, at the circumferential-direction center of the outer circumferential surface, a first groove 404k which extends in the axial direction and of which the cross section perpendicular to the axial direction has a dovetail groove shape. A split core 431 has, at the circumferential-direction center of the outer circumferential surface, a second groove 431k which extends in the axial direction over the entire length of the split core 431 and of which the cross section perpendicular to the axial direction has a dovetail groove shape. The first grooves 404k and the second groove 431k become wider toward a radially inner side.

In a state in which the end-surface insulating members 404 are respectively attached to both end surfaces in the axial direction of the split core 431, the first grooves 404k of the two end-surface insulating members 404 and the second groove 431k of the split core 431 communicate with each other straightly. As shown in FIG. 13A, the two first grooves 404k appear to overlap the second groove 431k as seen in the axial direction.

The outer side surfaces in the circumferential direction of holding nails 479a, 479b of the retention tool 479 are sloped along both side walls 4S of the groove formed by the two first grooves 404k and the second groove 431k. The holding nails 479a, 479b are movable in the circumferential direction inside the first grooves 404k and the second groove 431k. After both holding nails are inserted into the first grooves 404k and the second groove 431k, when the holding nails are moved in the circumferential direction so as to be separated from each other, each holding nail is fitted and fixed along one of both side walls 4S formed by the two first grooves 404k and the second groove 431k.

The split core unit, the rotary electric machine, the method for manufacturing the split core unit, and the method for manufacturing the rotary electric machine according to the present embodiment, as in the effects described in embodiment 3, prevent the position of the split core unit intermediate body 430A from being displaced in the radial direction during winding of the magnet wire W, whereby winding accuracy for the magnet wire W and productivity for the split core unit and the rotary electric machine can be further improved.

### Embodiment 5

Hereinafter, a split core unit, a rotary electric machine, a method for manufacturing a split core unit, and a method for manufacturing a rotary electric machine according to embodiment 5 of the present invention, will be described with reference to the drawings.

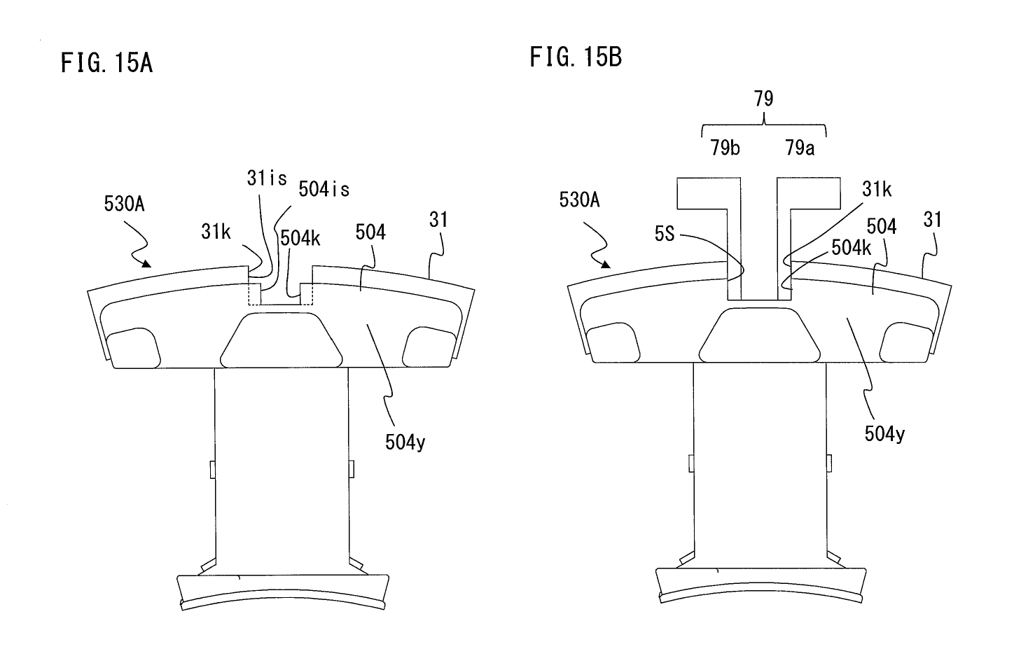

FIG. 15A is a front view of a split core unit intermediate body 530A.

FIG. 15B shows a state of fixation between the retention tool 79, and two first grooves 504k and the second groove 31k.

A yoke covering portion 504y of an end-surface insulating member 504 has, at the circumferential-direction center of the outer circumferential surface, the first groove 504k which extends in the axial direction and of which the cross section perpendicular to the axial direction has a rectangular shape that opens on one side. The split core 31 has, at the circumferential-direction center of the outer circumferential surface, the second groove 31k which extends in the axial direction over the entire length of the split core 31 and of which the cross section perpendicular to the axial direction has a rectangular shape that opens on one side. In a state before holding by the retention tool 79, as shown in FIG. 15A, the width in the circumferential direction of the first grooves 504k is smaller than the width in the circumferential direction of the second groove 31k. It is noted that, in FIG. 15A, these widths in the circumferential direction are shown in an exaggerated manner.

In a state in which the end-surface insulating members 504 are attached to both end surfaces in the axial direction of the split core 31, the first grooves 504k of the two end-surface insulating members 504 and the second groove 31k of the split core 31 communicate with each other straightly. In this state, as shown in FIG. 15A, side walls 504is of each first groove 504k protrude inward in the circumferential direction as compared to side walls 31is of the second groove 31k, and the two first grooves 504k appear to overlap the second groove 31k as seen in the axial direction.

As for the retention tool, the same retention tool 79 as in embodiment 1 is used. The holding nails 79a, 79b are movable in the circumferential direction inside the first grooves 504k and the second groove 31k. After both holding nails are inserted into the first grooves 504k and the second groove 31k, when the holding nails are moved in the circumferential direction so as to be separated from each other, first, the holding nails 79a, 79b come into contact with both side walls 504is of each first groove 504k to elastically deform them toward the respective opposite sides in the circumferential direction. When the holding nails 79a, 79b are moved so that the distance between the holding nails 79a, 79b further expands, each holding nail 79a, 79b is fitted and fixed along one of both side walls 5S of the groove formed by the two first grooves 504k and the second groove 31k. In this way, by elastically deforming the side walls 504is of each first groove 504k first, the holding nails 79a, 79b are assuredly fitted and fixed along one of the side walls 5S of the groove formed by the two first grooves 504k and the second groove 31k.

The split core unit, the rotary electric machine, the method for manufacturing the split core unit, and the method for manufacturing the rotary electric machine according to the present embodiment provide the effects described in embodiment 1 and in addition, enable the two end-surface insulating members 504 to be assuredly fixed to the holding nails 79a, 79b by elastically deforming the two end-surface insulating members 504 and using the repulsive force thereof at the time of winding of the magnet wire W. Thus, winding accuracy for the magnet wire W and productivity for the split core unit and the rotary electric machine can be further improved.

### Embodiment 6

Hereinafter, a split core unit, a rotary electric machine, a method for manufacturing a split core unit, and a method for manufacturing a rotary electric machine according to embodiment 6 of the present invention, will be described with reference to the drawings.

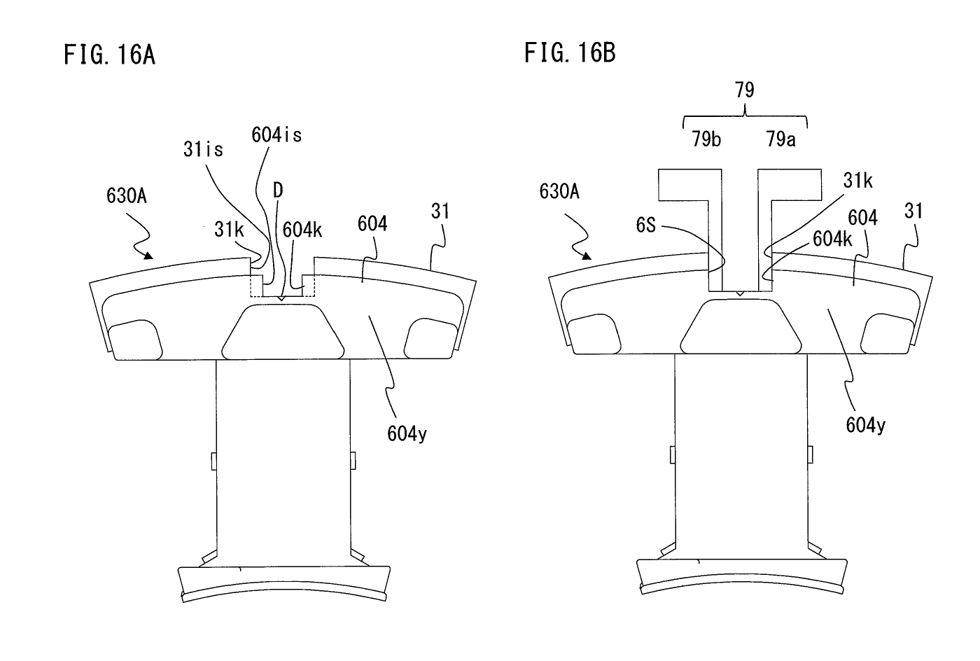

FIG. 16A is a front view of a split core unit intermediate body 630A.

FIG. 16B shows a state of fixation between the retention tool 79, and two first grooves 604k and the second groove 31k.

A yoke covering portion 604y of an end-surface insulating member 604 has, at the circumferential-direction center of the outer circumferential surface, a first groove 604k which extends in the axial direction and of which the cross section perpendicular to the axial direction has a rectangular shape that opens on one side. The split core 31 has, at the circumferential-direction center of the outer circumferential surface, the second groove 31k which extends in the axial direction over the entire length of the split core 31 and of which the cross section perpendicular to the axial direction has a rectangular shape that opens on one side. A difference between the end-surface insulating member 504 described in embodiment 5 and the end-surface insulating member 604 used in the present embodiment is that the first groove 604k of the end-surface insulating member 604 has, at the circumferential-direction center in the bottom of the first groove 604k, a cutout D which is formed over the entire length in the axial direction and of which the cross section perpendicular to the axial direction has a V shape.

In a state in which the end-surface insulating members 604 are attached to both end surfaces in the axial direction of the split core 31, the first grooves 604k of the two end-surface insulating members 604 and the second groove 31k of the split core 31 communicate with each other straightly. In this state, as shown in FIG. 16A, side walls 604is of the first groove 604k protrude inward in the circumferential direction as compared to side wall 31is of the second groove 31k, and the two first grooves 604k appear to overlap the second groove 31k as seen in the axial direction.

The holding nails 79a, 79b of the retention tool 79 are movable in the circumferential direction inside the first grooves 604k and the second groove 31k. After both holding nails are inserted into the first grooves 604k and the second groove 31k, when the holding nails are moved in the circumferential direction so as to be separated from each other, first, the holding nails 79a, 79b come into contact with both side walls 604is of each first groove 604k to elastically deform them toward the respective opposite sides in the circumferential direction. When the holding nails 79a, 79b are moved so that the distance between the holding nails 79a, 79b further expands, each holding nail 79a, 79b is fitted and fixed along one of both side walls 6S of the groove formed by the two first grooves 604k and the second groove 31k. At this time, the cutout D provided at the center of the bottom of each first groove 604k facilitates the elastic deformation, whereby fitting and fixation by the holding nails 79a, 79b can be facilitated.

Thus, the split core unit, the rotary electric machine, the method for manufacturing the split core unit, and the method for manufacturing the rotary electric machine according to the present embodiment 6 enable the amount of elastic deformation described in embodiment 5 to be adjusted easily, whereby winding accuracy for the magnet wire W and productivity for the split core unit and the rotary electric machine can be further improved.

It is noted that, within the scope of the present invention, the above embodiments may be freely combined with each other, or each of the above embodiments may be modified or simplified as appropriate.

### DESCRIPTION OF THE REFERENCE CHARACTERS

100 rotary electric machine

1 frame

2 rotor

3 stator

30 split core unit

30A, 230A, 330A, 430A, 530A, 630A split core unit intermediate body

31, 231, 331, 431 split core

31k, 331k, 431k second groove

31s shoe portion

31sg outer circumferential surface

31t, 231t tooth portion

31tin inner end

31ts circumferential-direction side surface

31y yoke portion

31yin inner circumferential surface

4, 304, 404, 504, 604 end-surface insulating member

4L guide groove

4R winding hook groove

4b, 4c engagement nail

4d protrusion

4k, 304k, 404k, 504k, 604k first groove

4in inner flange

4out outer flange

4t tooth covering portion

4y, 304y, 404y, 504y, 604y yoke covering portion

5 coil

5St winding start end

6 side-surface insulating member

6t axial end portion

70 winding device

70B flyer winding device

75 chuck

76, 76B, 276 nozzle

77 flyer

79, 279, 379, 479 retention tool

79a, 79b, 379a, 379b, 479a, 479b holding nail

W magnet wire

CL axial direction

A line

B center axis

C arrow

S, 3S, 4S, 5S, 6S, 31is, 504is, 604is side wall

1-11. (canceled)

12. A split core unit comprising:
a split core having a yoke portion and a tooth portion protruding radially inward from the yoke portion;
a coil formed by winding a magnet wire around the tooth portion; and
an insulating member electrically insulating the split core and the coil from each other, wherein
the insulating member has end-surface insulating members respectively covering both end surfaces in an axial direction of the split core,
each end-surface insulating member has, at a circumferential-direction center of an outer circumferential surface thereof, a straight-shaped first groove extending in the axial direction,
the yoke portion has, at a circumferential-direction center of an outer circumferential surface of the split core, a straight-shaped second groove extending in the axial direction over an entire length of the yoke portion,
the two first grooves and the second groove communicate with each other,
the two first grooves appear to overlap the second groove as seen in the axial direction, and
a circumferential-direction width of each first groove is smaller than a circumferential-direction width of the second groove.

13. The split core unit according to claim 12, wherein
the first grooves and the second groove are each formed such that a cross section thereof perpendicular to the axial direction has a rectangular shape that opens on one side.

14. The split core unit according to claim 12, wherein
the first grooves and the second groove are each formed such that a cross section thereof perpendicular to the axial direction has a T shape in which a bottom of each of the first grooves and the second groove spreads in a circumferential direction.

15. The split core unit according to claim 12, wherein
the first grooves and the second groove are each formed such that a cross section thereof perpendicular to the axial direction has a dovetail groove shape that becomes wider toward a radially inner side.

16. The split core unit according to claim 12, wherein
each end-surface insulating member has:
a pair of first engagement nails engaged with outer circumferential surfaces of shoe portions protruding toward both sides in a circumferential direction from a radially inner end of the tooth portion; and
a pair of second engagement nails engaged with an inner circumferential surface of the yoke portion.

17. The split core unit according to claim 13, wherein
each end-surface insulating member has:
a pair of first engagement nails engaged with outer circumferential surfaces of shoe portions protruding toward both sides in a circumferential direction from a radially inner end of the tooth portion; and
a pair of second engagement nails engaged with an inner circumferential surface of the yoke portion.

18. The split core unit according to claim 14, wherein
each end-surface insulating member has:
a pair of first engagement nails engaged with outer circumferential surfaces of shoe portions protruding toward both sides in a circumferential direction from a radially inner end of the tooth portion; and
a pair of second engagement nails engaged with an inner circumferential surface of the yoke portion.

19. The split core unit according to claim 15, wherein
each end-surface insulating member has:
a pair of first engagement nails engaged with outer circumferential surfaces of shoe portions protruding toward both sides in a circumferential direction from a radially inner end of the tooth portion; and
a pair of second engagement nails engaged with an inner circumferential surface of the yoke portion.

20. The split core unit according to claim 12, wherein
each first groove has, at a circumferential-direction center of a bottom thereof, a cutout formed over an entire length in the axial direction.

21. The split core unit according to claim 13, wherein
each first groove has, at a circumferential-direction center of a bottom thereof, a cutout formed over an entire length in the axial direction.

22. The split core unit according to claim 14, wherein
each first groove has, at a circumferential-direction center of a bottom thereof, a cutout formed over an entire length in the axial direction.

23. The split core unit according to claim 15, wherein
each first groove has, at a circumferential-direction center of a bottom thereof, a cutout formed over an entire length in the axial direction.

24. The split core unit according to claim 16, wherein
each first groove has, at a circumferential-direction center of a bottom thereof, a cutout formed over an entire length in the axial direction.

25. The split core unit according to claim 17, wherein
each first groove has, at a circumferential-direction center of a bottom thereof, a cutout formed over an entire length in the axial direction.

26. The split core unit according to claim 18, wherein
each first groove has, at a circumferential-direction center of a bottom thereof, a cutout formed over an entire length in the axial direction.

27. The split core unit according to claim 19, wherein
each first groove has, at a circumferential-direction center of a bottom thereof, a cutout formed over an entire length in the axial direction.

28. A rotary electric machine comprising:
a stator formed by combining, in an annular shape, a plurality of the split core units according to claim 12;
a frame that houses the stator; and
a rotor rotatably supported on an inner side of the stator.

29. The rotary electric machine according to claim 28, wherein
the split cores adjacent to each other in a circumferential direction are joined to each other.

30. A method for manufacturing a split core unit,
the split core unit comprising:
a split core having a yoke portion and a tooth portion protruding radially inward from the yoke portion;
a coil formed by winding a magnet wire around the tooth portion; and
an insulating member electrically insulating the split core and the coil from each other, wherein
the insulating member has end-surface insulating members respectively covering both end surfaces in an axial direction of the split core,
each end-surface insulating member has, at a circumferential-direction center of an outer circumferential surface thereof, a straight-shaped first groove extending in the axial direction,
the yoke portion has, at a circumferential-direction center of an outer circumferential surface of the split core, a straight-shaped second groove extending in the axial direction over an entire length of the yoke portion,
the two first grooves and the second groove communicate with each other, and
the two first grooves appear to overlap the second groove as seen in the axial direction,
the method comprising:
an insulating member attachment step of attaching each end-surface insulating member to the split core;
a fixation step of inserting a holding tool having two holding nails longer than an axial length of the split core and openable and closable in a circumferential direction, into the two first grooves and the second groove, in a state in which the two holding nails are closed, and then opening the two holding nails in the circumferential direction, to press both side walls of the two first grooves and the second groove in the circumferential direction by the two holding nails, thereby fixing the two end-surface insulating members and the split core to the holding tool; and
a winding step of forming the coil by winding a magnet wire around a split core unit intermediate body in which the two end-surface insulating members and the split core are fixed to each other.

31. A method for manufacturing a rotary electric machine, the method comprising:
a split core unit joining step of combining, in an annular shape, a plurality of the split core units manufactured by the method for manufacturing the split core unit according to claim 30, to form a stator; and
a rotary electric machine assembling step of inserting the stator into a frame and fixing the stator, and rotatably providing a rotor to inside of the stator.
